(19) United States
(12) Patent Application Publication
(10) Pub. No.: US 2008/0250903 A1
(43) Pub. Date: Oct. 16, 2008

(54) Efficient driving tool for driving a screwing device

(76) Inventor: Chih-Ching Hsieh, Taichung City (TW)

Correspondence Address: Chi-Ching Hsieh, Box 8-24, 235 Chung-Ho, Taipei, TW

(21) Appl. No.: 11/786,348

(22) Filed: Apr. 12, 2007

(51) Int. Cl. B25B 13/46

(52) U.S. Cl. 81/60; 81/177.85

(57) ABSTRACT

A efficient driving tool for driving a screwing device, comprises: a driving head extending from the shank; the driving head having a receiving hole with a ratchet ring received therein; one lateral side of the driving head having a receiving groove. The ratchet ring has an engaging hole with a teeth set therein. A recess between two adjacent teeth is formed by two small arcs and one large arc; the large arc is at a bottom section of the recess and two small arcs are at tops of the recess. A straight section is between each small arc and the large arc; a section between two small arcs of two adjacent recesses is a transversal section which is a straight line. The screw device is one of a spanner and a socket.

### FIELD OF THE INVENTION

The present invention relates to an efficient driving tool for driving a screwing device, wherein the teeth in the screwing device is special designed with a predetermined shape and a specific ratio so as to increment the efficiency of the transfer of force and protect the working tool from destroying, wearing and cracking.

### BACKGROUND OF THE INVENTION

For a ratchet spanner, the teeth set in the spanner is used to contact with a screw element. All the forces of the spanner transferred to the screw element are transferred through the teeth in the ratchet ring of the spanner. Thus it is very important to design the shape or ratios of the different sections in the teeth so that the force can be transferred to the screw element effectively. If the design of the teeth is not perfect, the force cannot be effectively transferred to the screw element and further the teeth of the ratchet ring or the screw element will be destroyed for a long time. Thus there are many improvements being disclosed for improving the efficiency in driving a spanner.

In one prior art structure, the teeth set of the ratchet ring have a plurality of protrusions and a plurality of recesses which are arranged alternatively. The recess serves to receive the apexes of the screw element and the protrusion serves to contact the surface of the screw element for providing twisting force to the screw element.

However, in the prior art way, the angles between different sections of the teeth and the recess are right angle and apex of angle will hurt the screw object and the contact is often point contact or the contact surface is not matched between the teeth of the ratchet ring and the contact surface of the screw object. As a result, the force cannot be effectively transferred to the screw object. Furthermore the right angle design in the ratchet ring makes the manufacturing process is tedious and inconvenient. As a whole, the prior art is necessary to be improved for getting an efficient spanner in driving and for protecting the spanner and screw object.

### SUMMARY OF THE INVENTION

Accordingly, the primary object of the present invention is to provide an efficient driving tool for driving a screwing device, wherein the teeth in the screwing device is specially designed with a predetermined shape and a specific ratio so as to increment the efficiency of the transfer of force and protect the working tool from destroying, wearing and cracking.

To achieve above objects, the present invention provides a crewing device with a function of twisting force measurement, comprising: a driving head extending from the shank; the driving head having a receiving hole with a ratchet ring received therein; one lateral side of the driving head having a receiving groove. The ratchet ring has an engaging hole with a teeth set therein. A recess between two adjacent teeth is formed by two small arcs and one large arc; the large arc is at a bottom section of the recess and two small arcs are at tops of the recess. A straight section is the between each small arc and the large arc; a section between two small arcs of two adjacent recesses is a transversal section which is a straight line. The screw device is one of a spanner and a socket.

The various objects and advantages of the present invention will be more readily understood from the following detailed description when read in conjunction with the appended drawing.

### BRIEF DESCRIPTION OF THE DRAWINGS

FIG. 1 is an exploded perspective view of the efficient driving tool for driving a screwing device of the present invention.

FIG. 2 is a perspective view of the present invention.

FIG. 3 is a schematic cross sectional view of the present invention.

FIG. 4 is a partial enlarged schematic view of the teeth set of the present invention.

FIG. 5 shows the perspective view of the second embodiment of the present invention.

FIG. 6 shows the application of socket in FIG. 5.

FIG. 7 shows the structure in the third embodiment of the present invention.

### DETAILED DESCRIPTION OF THE INVENTION

In order that those skilled in the art can further understand the present invention, a description will be provided in the following in details. However, these descriptions and the appended drawings are only used to cause those skilled in the art to understand the objects, features, and characteristics of the present invention, but not to be used to confine the scope and spirit of the present invention defined in the appended claims.

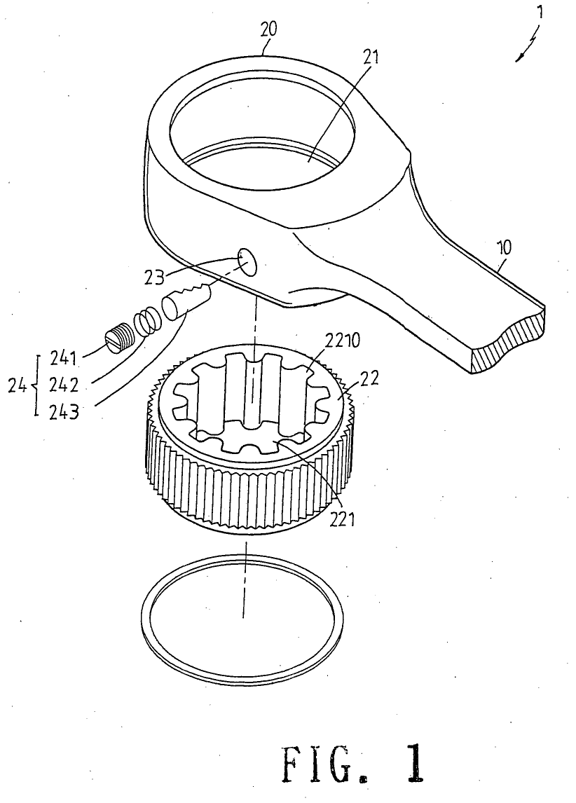

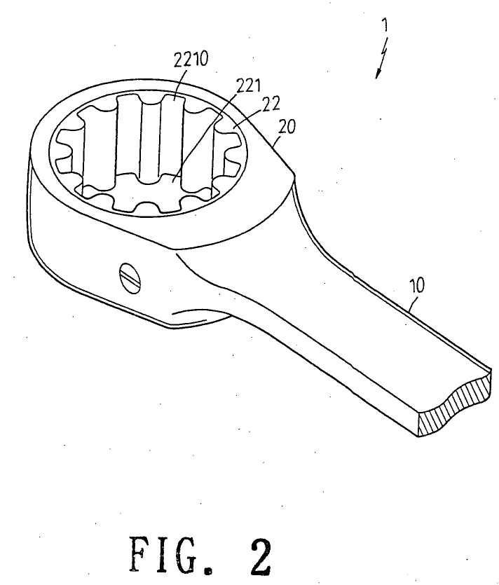

Referring to FIGS. 1 to 4, the structure of the present invention is illustrated. The present invention has the following elements:

A shank 10 is included.

A driving head 20 extends from the shank 10. The driving head 20 has a receiving hole 21 with a ratchet ring 22 received therein. One lateral side of the driving head 20 has a receiving groove 23.

A buckling unit 24 is received in the receiving groove 23. The buckling unit 24 has a positioning unit 241, an elastic unit 242 and a latch unit 243. By the positioning unit 241, the elastic unit 242 and latch unit 243 are positioned in the receiving groove 23. The elastic unit 242 will push the latch unit 243 so as to be engaged with the ratchet ring 22 so that the ratchet ring 22 moves unidirectionally.

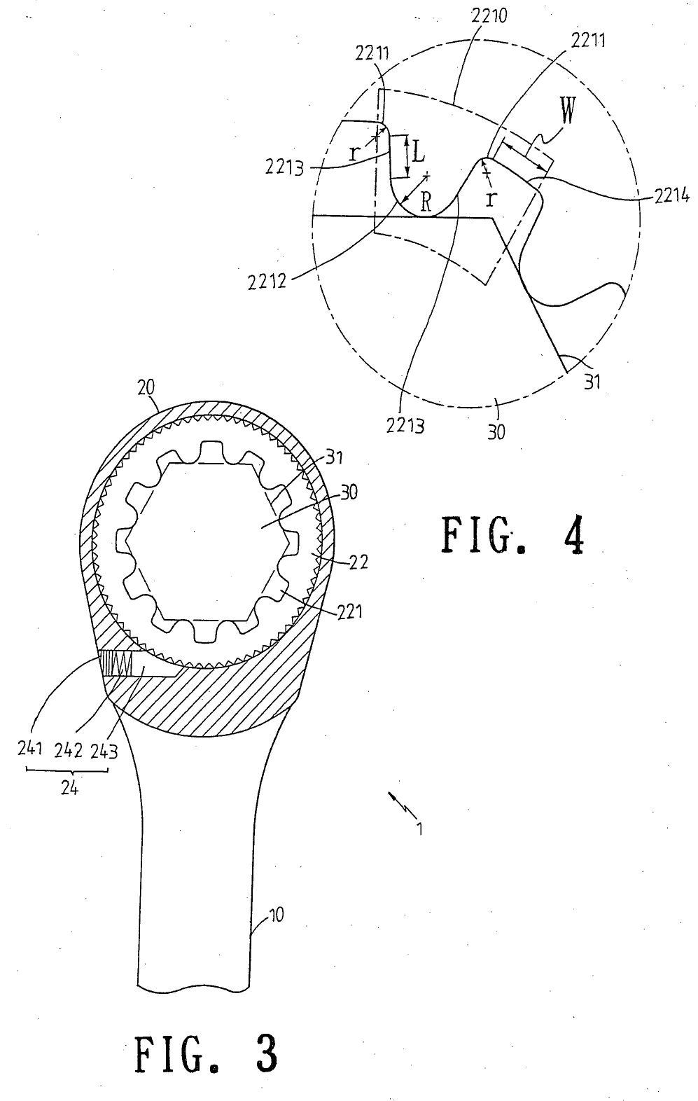

Referring to FIGS. 3 and 4, the ratchet ring 22 has an engaging hole 221 with a teeth set 2210 therein. FIG. 4 shows the details of the teeth. With reference to the section indicated by the dashed lines, it is illustrated that a recess between two teeth is formed by two small arcs 2211 and one large arc 2212. In detail, the large arc 2212 is at a bottom section of the recess and two small arcs 2211 are at tops of the recess. A straight section 2213 serves to connect the small arc 2211 and the large arc 2212. A section between two small arcs 2211 of two adjacent recesses is a transversal section 2214 which is a straight line. The radius of the small arc 2211 is “r”, the radius of the large arc 2212 is “R”. The length of the straight section 2213 is L and a length of the transversal section 2214 is L. In the present invention, the ratios of r:R:L:W are 3:9:10:14.

About mentioned feature is beneficial to the driving the engaging hole 221 so as to prevent the engaging hole 221 is destroyed in the driving operation. Furthermore the engaging hole 221 can be made easily.

Moreover, when a screw unit is received in the engaging hole 221, the large arc 2212 with a radius R resists against a screw unit 30. The ratio can prevent the screw unit 30 to slide. Thus the contact surface of the screw unit 30 is positioned precisely.

In the present invention, the radius of the small arc 2211 is “r”, the radius of the large arc 2212 is “R”. The length of the straight section 2213 is L and a length of the transversal section 2214 is L. In the present invention, the ratios of r:R:L:W are 3:9:10:14. Thus in the manufacturing process, the quality is retained.

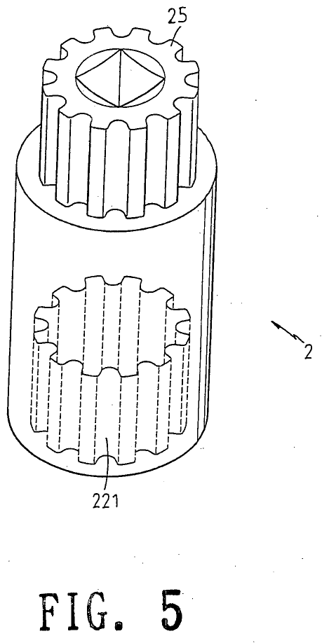

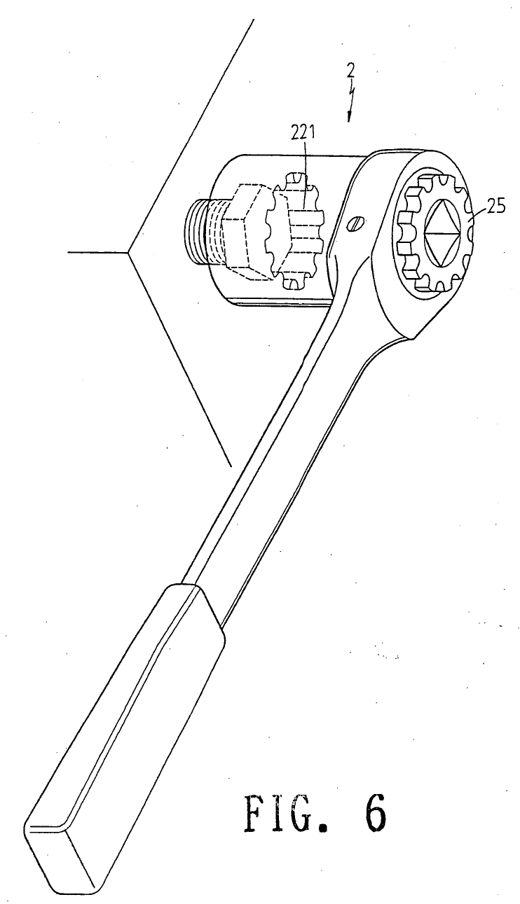

Referring to FIGS. 5 and 6, the second embodiments of the present invention are illustrated. In this embodiment, those identical to the above mentioned embodiment will not be further described herein. Only those difference are disclosed. It is illustrated that the present invention is used to a socket. 2. An upper side of the socket 2 has a teeth protrusion 25 with a plurality of teeth annually arranged around an outer side of the protrusion 25. A lower side of the socket 2 is a hole 221 and an inner wall of the recess 221 is teethed. The length ratio of different sections in teeth in the protrusion 25 and lower hole 221 has the same ration as those illustrated in FIGS. 1 to 4. FIG. 6 shows the use of the socket 2, in that the protrusion 25 of the socket 2 is engaged to a ratchet spanner and hole 221 of the socket 2 serves to clamp a screw for screwing the screw.

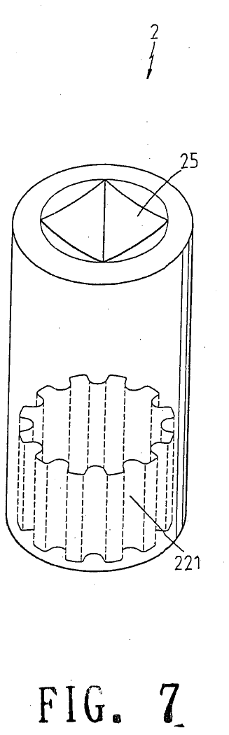

Referring to FIG. 7, another embodiment of the present invention is illustrated. The structure in this embodiment is almost identical to that in FIGS. 5 and 6, but the protrusion 25 in FIG. 5 is replaced by a rectangular hole, however, the length ratio of different sections in teeth of the lower hole 221 has the same ration as those illustrated in FIGS. 1 to 4.

The present invention is thus described, it will be obvious that the same may be varied in many ways. Such variations are not to be regarded as a departure from the spirit and scope of the present invention, and all such modifications as would be obvious to one skilled in the art are intended to be included within the scope of the following claims.

What is claimed is:

1. An efficient driving tool for driving a screwing device, comprising:
a shank;
a driving head extending from the shank; the driving head having a receiving hole with a ratchet ring received therein; one lateral side of the driving head having a receiving groove;
wherein the ratchet ring has an engaging hole with a teeth set therein; a recess between two adjacent teeth is formed by two small arcs and one large arc; the large arc is at a bottom section of the recess and two small arcs are at tops of the recess; a straight section is between each small arc and the large arc; a section between two small arcs of two adjacent recesses is a transversal section which is a straight line.

2. The efficient driving tool for driving a screwing device as claimed in claim 1, wherein the radius of the small arc is “r”, the radius of the large arc is “R”; the length of the straight section is L and the a length of the transversal section is W, the ratios of r:R:L:W are 3:9:10:14.

3. The efficient driving tool for driving a screwing device as claimed in claim 1, wherein a buckling unit is received in the receiving groove; the buckling unit has a positioning unit, an elastic unit and a latch unit; by the positioning unit, the elastic unit and latch unit are positioned in the receiving groove.

4. A efficient driving tool for driving a screwing device comprising:
a socket;
wherein an upper side of the socket has a teeth protrusion with a plurality of teeth annually arranged around an outer side of the protrusion; a lower side of the socket is a hole and an inner wall of the recess is teethed; the length ratios of different sections of the teeth in the protrusion and the teeth in the lower hole are identical;
wherein a recess between two adjacent teeth of the protrusion and the hole is formed by two small arcs and one large arc; the large arc is at a bottom section of the recess and two small arcs are at tops of the recess; a straight section is between each small arc and the large arc; and a section between two small arcs of two adjacent recesses is a transversal section which is a straight line.

5. The efficient driving tool for driving a screwing device as claimed in claim 4, wherein the radius of the small arc is “r”, the radius of the large arc is “R”; the length of the straight section is L and the a length of the transversal section is W, the ratios of r:R:L:W are 3:9:10:14.

6. A efficient driving tool for driving a screwing device comprising:
a socket;
wherein an upper side of the socket has a rectangular hole; a lower side of the socket is a hole and an inner wall of the recess is teethed; and
wherein a recess between two adjacent teeth of the hole is formed by two small arcs and one large arc; the large arc is at a bottom section of the recess and two small arcs are at tops of the recess; a straight section is between each small arc and the large arc; and a section between two small arcs of two adjacent recesses is a transversal section which is a straight line.

7. The efficient driving tool for driving a screwing device as claimed in claim 6, wherein the radius of the small arc is “r”, the radius of the large arc is “R”; the length of the straight section is L and the a length of the transversal section is W, the ratios of r:R:L:W are 3:9:10:14.
